(19) United States
(12) Patent Application Publication
(10) Pub. No.: US 2025/0002403 A1
(43) Pub. Date: Jan. 2, 2025

(54) GLASS PARTS AND INFRARED FIBER PREFORM MANUFACTURING IN MICROGRAVITY

(71) Applicant: DSTAR Communications, Inc., Woodland Hills, CA (US)

(72) Inventor: Dmitry Starodubov, Woodland Hills, CA (US)

(73) Assignee: DSTAR Communications, Inc., Woodland Hills, CA (US)

(21) Appl. No.: 18/292,147

(22) PCT Filed: Jul. 27, 2022
(86) PCT No.: PCT/US2022/038602

§ 371 Date: Jan. 25, 2024

Related U.S. Application Data
(60) Provisional application No. 63/203,665, filed on Jul. 27, 2021.

(51) Int. Cl. C03C 25/1065; C03C 3/32

(52) U.S. Cl. CPC C03C 25/109; C03C 3/325; C03C 2217/21; C03C 2217/285; C03C 2218/35

(57) ABSTRACT

Embodiments are directed to systems and methods for material processing in a low gravity environment, and an optical fiber formed in a low gravity environment. In at least one embodiment, a glass part (e.g., a preform, optical fiber, optical waveguide, etc.) is produced by printing one or more glass materials using nozzles fed by heated apparatuses (e.g., syringes or crucibles).

### CROSS-REFERENCE TO RELATED APPLICATIONS

This application claims priority to U.S. Patent Application Ser. No. 63/203,665, filed on Jul. 27, 2021 and titled “GLASS PARTS AND INFRARED FIBER PREFORM MANUFACTURING IN MICROGRAVITY.” The disclosure of the prior application is incorporated by reference herein in its entirety.

### TECHNICAL FIELD

This disclosure is related to glass part manufacturing, and more specifically to glass parts and fiber preform manufacturing in microgravity environments.

### BACKGROUND

An optical fiber is a flexible, transparent fiber, often made of glass (silica) or plastic. Optical fibers are used to transmit light between the two ends of the fiber and have practical applications in the fields of fiber-optic communications, where they permit transmission over longer distances and at higher bandwidths (data rates) than wire cables. Optical fibers exhibit low attenuation characteristics and low electromagnetic interference, as compared to metal wires. Therefore, optical fibers can accommodate higher bandwidth, as mentioned, and/or longer transmission distances. Optical fiber has other uses, such as in laser applications, imaging applications, and lighting applications.

### BRIEF DESCRIPTION OF THE DRAWINGS

FIG. 1 is an example system for fabricating a preform using extrusion in accordance with embodiments of the present disclosure.

FIG. 2 is another example system for fabricating a preform using extrusion in accordance with embodiments of the present disclosure.

FIG. 3 illustrates an example fabrication of a planar waveguide circuit in accordance with embodiments of the present disclosure.

FIG. 4 is a cross section of the fiber preform comprising non-oxide and oxide glasses in accordance with embodiments of the present disclosure.

FIG. 5 is a cross section of a fiber with several cladding layers and cladding guiding optimized for fiber laser applications in accordance with embodiments of the present disclosure.

FIG. 6 is an example of an extruded optical element use for conditioning the output of semiconductor laser.

### DETAILED DESCRIPTION

Certain aspects of the present disclosure are directed to a system for manufacturing glass parts (e.g., optical fiber or waveguides) in low gravity environments, such as aboard space-borne vehicles or platforms. In this disclosure, the terms “low gravity environments” or “microgravity environments” may refer to environments with gravitational forces of g≤10-2 G for two or more minutes. For example, a low/microgravity environment can include a space-borne vehicle/platform, such as the International Space Station (ISS), other orbital platforms, or orbital vehicles.

Infrared optical elements, optical waveguides, and optical fibers can, in theory, have intrinsic losses that are lower than widely used silica fibers. The manufacturing methods for non-silica preforms and fibers, however, have not been developed to a level that enables scalable manufacturing with consistent optical fiber quality and reliability. Recent efforts have been made to manufacture low loss infrared optical fibers in low gravity (e.g., microgravity) environments to meet the growing demand of optical data networks. In these efforts, fluoride glass preforms with a fluoride glass core and fluoride glass cladding were produced on Earth (which may also be referred to as “on ground”) using a spin cast method. The preforms were then coated with a Teflon FEP (fluorinated ethylene propylene) coating, sent to the orbital platform of the International Space Station, drawn into a fiber and brought back to Earth.

These efforts showed several challenges with this process, however. For instance, they showed that the preforms carry defects from the processing on ground. In addition, the Teflon FEP coating does not provide sufficient protection from moisture and oxygen for the fluoride preform and the fluoride fiber. Thus, the resulting fiber delivered to Earth is very brittle, and the fiber cannot be easily stripped of its polymer coat without breaking. As such, the fiber cannot be reliably terminated and connectorized for reliable operation in the field.

The fluoride fiber draw may require inert atmosphere that is challenging to implement within the human habitat of the International Space Station or other orbital platforms. Suppression of convection heating/cooling in the low/microgravity environment in combination with low thermal conductivity of the fluoride glass preforms results in substantial thermal gradients across the preform, which sets a limit for a maximum diameter of the preform that can be drawn without overheating the outer part of the perform while still softening the inner part of the preform. The outer part of the preform is exposed to radiative heat transfer from the crucible and low thermal conductivity of the fluoride glass for large diameter preforms may result in overheating and crystalizing of the outer portion of the perform before the softening of the inner portion of the preform is achieved. This limits the maximum size of the preforms that can be used for infrared fiber manufacturing and prevents the scaling of the manufacturing process.

Coating of fluoride glass with oxide glasses has been reported using spin casting preform manufacturing method (e.g., in U.S. Pat. No. 4,883,339), whose approach addresses the challenge of environmental sensitivity of fluoride optical fibers during the draw and later use in the field. The established spin casting method, however, is challenging to implement in low or microgravity environments since the molten glass pouring into a spinning cast cannot be easily implemented without the presence of gravity.

Aspects of the present disclosure relate to scalable manufacturing methods for optical elements, optical waveguides, infrared optical fibers and fiber preforms with low insertion loss and low environmental sensitivity. Some embodiments herein can be referred to as a “triple crucible process”, analogous to the known dual crucible manufacturing methods in the art. Other embodiments may be considered as a sort of three-dimensional printing of glass parts, e.g., planar waveguides or fiber on a substrate. Aspects herein can enable scalable production of high quality, low loss infrared optical fibers. Further, aspects herein may be compatible with low/microgravity manufacturing environments and can be used for sustainable production of optical fibers, high-quality fiber preforms, or other types of glass parts in space or other low gravity environments.

Preform fabrication may be performed using extrusion of non-oxide and oxide glass materials. In some embodiments, the extrusion of non-oxide and oxide glasses is performed simultaneously, and the outer portion of the extrusion is represented by oxide glass with lower environmental sensitivity and better thermal conductivity. In certain embodiments, the extrusion of three glass materials is performed, with two inner materials being an infrared fluoride glass core and an infrared fluoride glass cladding, and the outer material being the oxide glass external cladding. The outer oxide glass cladding can be further coated with a polymer material, such as a Teflon FEP material, ether by extrusion, or by heat shrinking the polymer tube over the glass preform. The fluoride core and fluoride cladding materials can be compositions that include indium fluoride, in certain embodiments. The extruder could be designed by those skilled in the art and can have three or more concentric nozzles in certain embodiments. The nozzles can move along the common axis to change the relative diameters for the extruded materials in certain embodiments.

In other embodiments, the extruder can have several separate nozzles, each with its own heating element. The formation of the preform with multiple glass compositions can be done additively from multiple nozzles layer by layer. The resulting device can operate as glass 3D printer in certain instances. An extruder of the present disclosure can fabricate a multi-glass fiber directly or fabricate a preform that can be used for optical fiber fabrication using known draw processes or other draw processes. The preform fabrication, the optical fiber draw from multi-glass preform, or both the preform extrusion and the draw can be implemented in a low/microgravity environment using aspects of the present disclosure. In certain embodiments, the methods disclosed herein can be implemented on ground (i.e., on Earth) in a low pressure environment, such as vacuum.

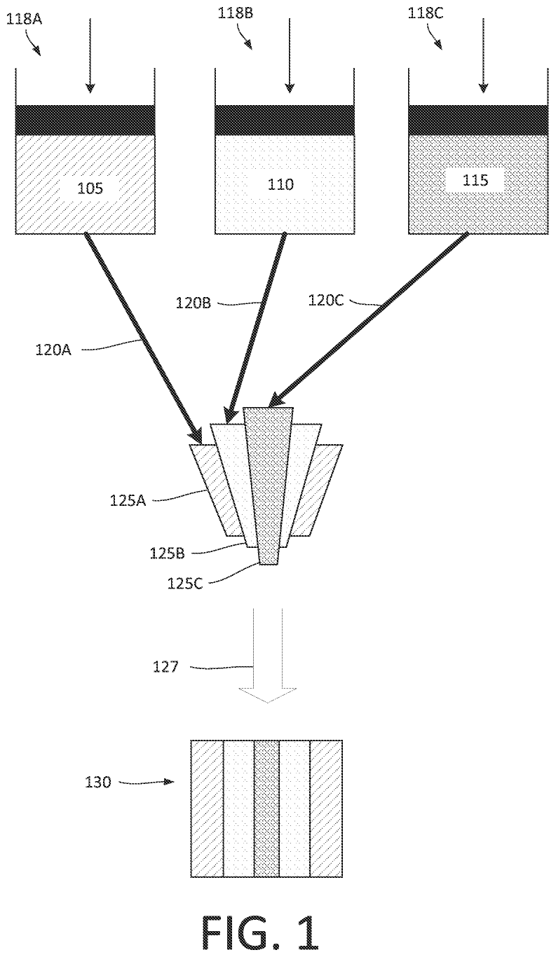

FIG. 1 is an example system 100 for fabricating a preform 130 using extrusion in accordance with embodiments of the present disclosure. In particular, FIG. 1 illustrates a so-called “triple crucible” method for manufacturing an optical fiber preform 130 with a concentric extrusion nozzle design that can change the ratio of extruded layers using relative motion of the concentric nozzles 125 along the direction of extrusion (i.e., up and down in the illustration). The extrusion method shown can deliver preforms with better quality than spin cast methods known in art and is also compatible with low/microgravity environments. In addition, the extrusion method can be used for making an optical fiber directly without using a draw process.

In the example shown, there are three heated syringes 118A-C, each containing a molten glass (105, 110, 115). In the example shown, the first syringe 118A extrudes an oxide cladding glass 105 that becomes an outer cladding layer of the preform 130, a second syringe 118B extrudes an infrared cladding glass 110 that becomes an inner cladding in the preform 130, and a third syringe 118C extrudes an infrared core glass 115 that becomes the core of the preform 130. In certain embodiments, the core and first cladding layer of the preform 130 may be suitable for use as a multimode fiber. The syringes 118 are functionally connected to respective concentric extruder nozzles 125A-C via conduits 120A-C. The ratio of the cross sections of the materials 105, 110, and 115 in the resulting preform 130 may be changed by moving the corresponding concentric nozzles 125 relative to each other along the extrusion direction 127. For instance, if the nozzle 125C is moved downward in the illustration, the diameter of the cladding material 110 in the resulting preform 130 may be reduced. In this way, the preform 130 may be made such that it includes variable diameters of the respective materials 105, 110, and 115. However, certain embodiments may produce a preform 130 with constant diameters in the respective materials.

Although described as heated syringes, in other embodiments, the items 118 may be heated crucibles or other types of heated apparatuses that can be used to extrude as described herein. For instance, rather than syringes feeding concentric nozzles, some embodiments may use three concentric crucibles, in a similar manner to a dual crucible manufacturing process, to produce a fiber preform.

In certain embodiments, rather than the material 105 being an infrared core glass material, it may be silver bromide (AgBr), with the material 110 being a silver chloride (AgCl) material. The system 100 may be used to create a preform 130 that has a gradient between the AgBr and AgCl layers. The outer layer 105 in such embodiments could be a phosphate bonding glass, or a similar material. In other embodiments, the materials 105, 110 may be a chalcogenide material (e.g., with arsenic telluride or arsenic selenide). Embodiments herein can be used along with aspects of U.S. Pat. No. 5,342,022 (describing silver chloride (AgCl), silver bromide (AgBr), and their solid solutions (AgClₓBr(₁₋ₓ₎) crystalline fiber manufacturing) and U.S. Pat. No. 5,879,426 (describing dual-crucible chalcogenide fiber manufacturing), both of which are incorporated herein by the reference.

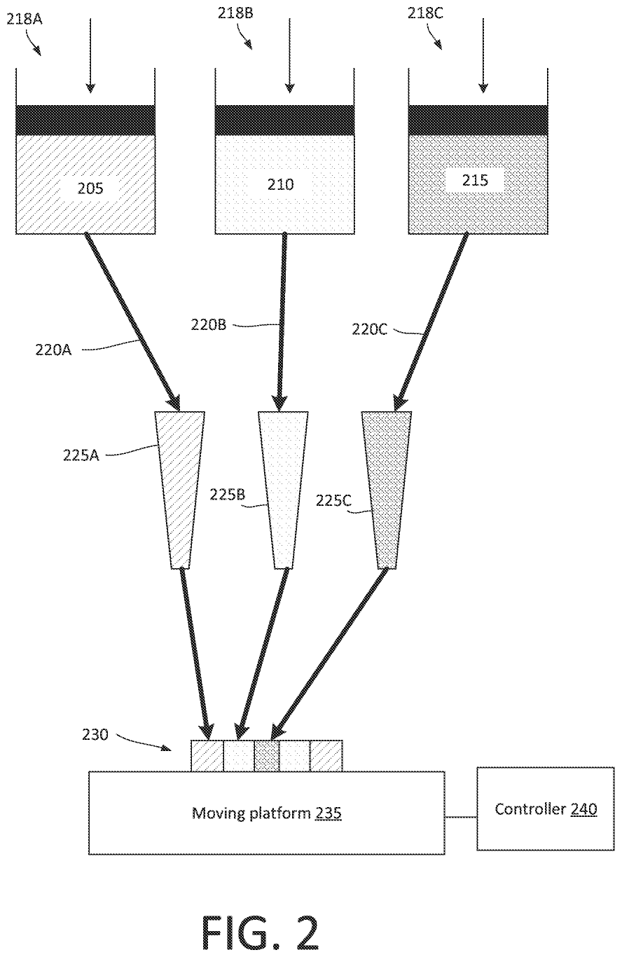

FIG. 2 is another example system 200 for fabricating a preform 230 using extrusion in accordance with embodiments of the present disclosure. In particular, FIG. 2 illustrates a multiple crucible method with multiple independent nozzles 225 that could be used for three-dimensional (3D) printing preforms (e.g., 230) or other parts out of multiple glass compositions in accordance with embodiments of the present disclosure. The example extrusion system 200 includes three separate heated syringes 218 for three respective glass materials 205, 210 and 215. The syringes 218 may be implemented in the same or a similar manner as the syringes 118 of FIG. 1. The configuration shown can be used if the difference in glass properties doesn't allow for simultaneous extrusion as shown in the system 100 of FIG. 1. The syringes 218 feed, via delivery means 220 (e.g., conduit) the respective glass materials to the extruders 225 in similar manner to the example shown in FIG. 1, and the extruders 225 print the glass materials onto a moving platform 235. The moving platform 235 may be controlled by a controller 240 to move in a manner that creates a resulting preform, which may be an optical fiber preform, optical waveguide, or other type of glass part.

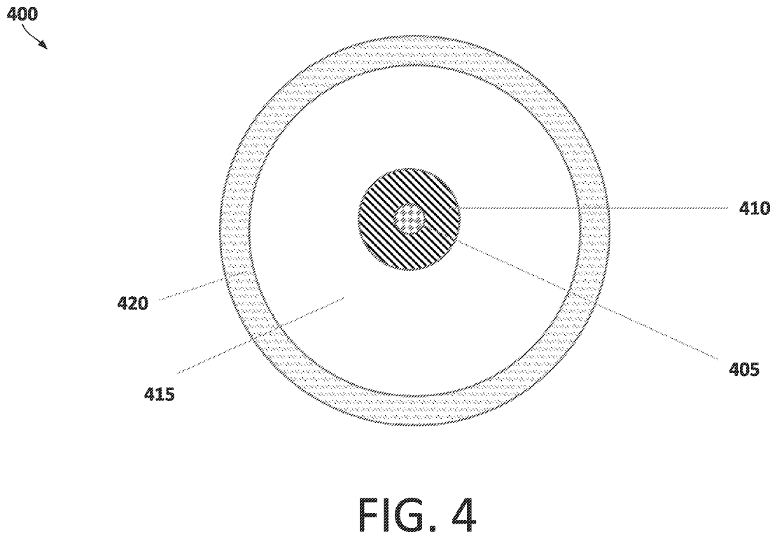

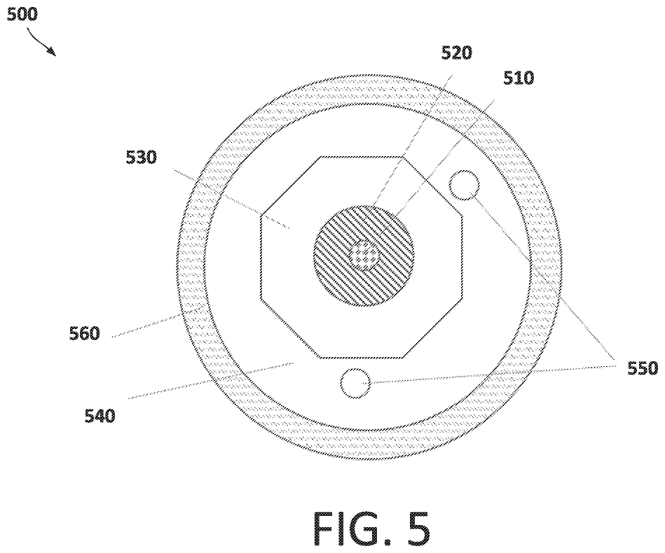

The resulting preform 230 (or other desired glass part) can have any desired 3D distribution of the respective glass materials, and can be fabricated layer by layer by aligning the operational nozzle 225 with a desired extruded position using the moving platform 235. For example, the system 200 can be used to produce a fiber preform by first printing a core layer, then printing each cladding layer around the core layer (or subsequent cladding layer(s)). The system 200, for instance, can be used to print an optical preform such as the preform 400 of FIG. 4 or a another type of preform (e.g., a typical preform with a core and one cladding layer). In some embodiments, the system 200 can be used to fabricate a fiber preform that has one or more layers that are non-concentric and/or non-round. For instance, the system 200 can be used to produce a preform, fiber, or optical element (e.g., waveguide) that has a square, hexagonal, octagonal, etc. cladding layer (e.g., similar to the layer 530 of the fiber 500 FIG. 5), whereas a system such as system 100 with concentric nozzles may produce preforms that have circular, concentric layers, e.g., similar to the preform 400 of FIG. 4. In certain embodiments, the system 200 can be used to manufacture a gradient preform, e.g., here the resulting preform has a gradient in a concentration of materials (e.g., dopants) at the center of the preform versus the sides of the preform. In other embodiments, the system 200 can be used to print waveguides, optical fiber, or other types of optical elements onto a substrate (e.g., a substrate that rests on the moving platform 235).

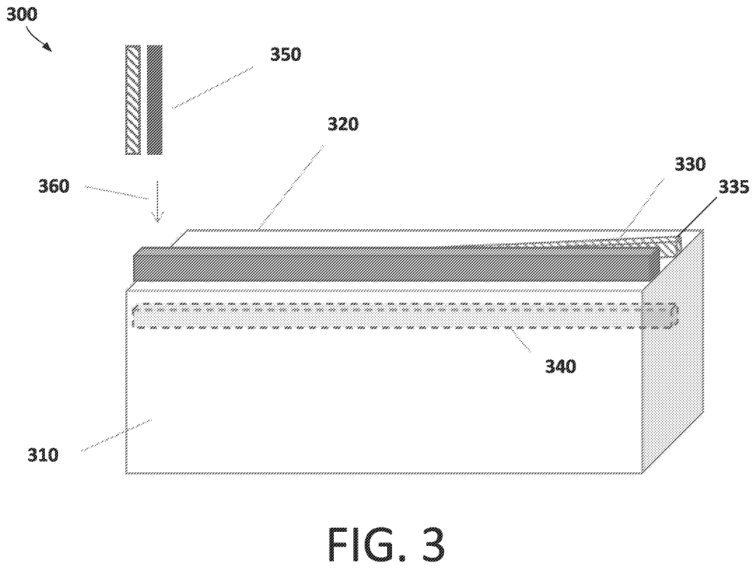

FIG. 3 illustrates an example fabrication of a planar waveguide circuit 300 in accordance with embodiments of the present disclosure. The planar waveguide circuit 300 may be a photonic light wave circuit with void channels for microfluidic capabilities and may be fabricated using extrusion methods of the present disclosure. In certain instances, the system 200 of FIG. 2 (with multiple nozzles for various glasses or metals) could be used for fabrication of the circuit 300, or for a wide variety of optical devices and components. The circuit 300 is fabricated on a top surface 320 of substrate 310 and includes waveguides 330, 335, 340 that can be fabricated using undoped glass or doped glass.

For instance, the use of extruded material from nozzles 350 (which may be implemented in the same or similar manner as the nozzles 225 of FIG. 2, e.g., may be fed by heated apparatuses such as heated syringes) could be used to form planar ridge waveguide structures 330, 335 on a substrate 310. These structures could be made of different materials such undoped materials for light guiding, combining, splitting. The materials could be rare-earth doped for making optical waveguide amplifiers. For instance, in the example shown, the waveguide 330 can be a doped guide, and the waveguide 335 can be a pump guide for the doped waveguide 330. In some embodiments, the present invention can be used for making buried waveguides (e.g., 340) by covering the ridge waveguides with the material that is similar to the substrate material 310 for reduction of insertion loss. The substrate 310 can be heated in certain embodiments, e.g., to establish the bonding of the deposited waveguides.

The circuit 300 can have a number of planar optical elements known in the art, such as, for example, splitters, couplers, combiners, resonators. Doped waveguides (e.g., 330) can be used for light amplification, laser action, Q-switching, distributed reflection (e.g., planar Bragg gratings). The voids in the circuit 300 can be used to guide liquids or form microfluidic channels in certain embodiments. Alternatively, in some embodiments, the voids can be filled with conductive material such as metal and can be used as conductors. The fabrication of the circuit 300 is done with extrusion nozzles 350 that can extrude multiple materials, including doped glass, undoped glass, and glass with void (e.g., a glass tube). The transfer 360 of the extrusion onto the substrate 310 can be laser assisted or heat assisted to ensure the proper bonding of the extrusion to the substrate. The laser could be CO or CO₂ laser, which can be used to locally heat the extrusion to ensure its bonding to the substrate 310.

The nozzles 350 of the present invention could be used to deposit mufti-layered elements, such as the element 130 in FIG. 1. The outer layer of the element 130 could be used for bonding to the substrate 310. The inner layers could maintain circularity and provide low loss light propagation on a rigid planar structure. The circular mode of such planar element will have compatibility with the optical fibers for the light coupling between optical fibers and planar waveguides with low insertion loss. The example of the planar structure that could be made using the method of present invention is a compact and rigid spool of optical gyroscope incorporated into a planar waveguide circuit with low insertion loss.

Although shown as waveguides running in one direction along the substrate, it will be understood that waveguides (or optical fibers) can be printed in any suitable direction on the substrate. For instance, in some embodiments, a waveguide or fiber can be printed in a spiral or spooled pattern to form a relatively long length of guide/fiber in a small area on the substrate.

Some examples of resulting devices that can be produced by the system 300 include planar photonic circuits, couplers, splitters, optical amplifiers, optical modulators, mode converters, microfluidic chips, and many others. The approach could be used for structural and functional elements fabrication including micro glass satellites fabrication in space with built-in antennas or extended and lightweight space structures.

FIG. 4 is a cross section of a fiber preform 400 comprising non-oxide and oxide glasses in accordance with embodiments of the present disclosure. The preform 400 may be produced using the systems 100, 200 of FIGS. 1, 2, in certain embodiments. The preform 400 includes a core 405 that is a low loss infrared glass material is used for light guiding. The core 405 may be made from a material, such as, for example, Indium fluoride, fluoride zirconate, beryllium fluoride or any other infrared glass composition with low insertion loss in the infrared spectrum. The core 405 may be optimized for multimode or single mode operation of a resulting fiber. The preform 400 also includes a first cladding 410 that is formed from an infrared glass material with a refractive index lower than the core 405. The difference in refractive indexes enables low loss light guiding in the core 405. The preform 400 also includes a second cladding 415, which may represent a large portion (e.g., majority portion) of the fiber preform cross section. The cladding 415 may be made of an oxide glass material with thermal conductivity that is higher than the thermal conductivity of the elements of the core 405 and the cladding 410. The glass transition temperature of the cladding 415 can be higher, approximately the same as, or lower than the glass transition temperature of the infrared glasses of the core 405 and cladding 410. In certain embodiments, the glass transition temperature of the cladding 415 is slightly higher (e.g., by 5-25 C) than the glass transition temperature of the core 405 and/or the cladding 410 (especially for larger preforms), which may compensate for a temperature gradient across the preform 400 during a fiber draw process. The preform 400 also includes a polymer coating 420 that can be applied using extrusion or heat shrinking methods, e.g., as described above. The polymer material may be Teflon FEP in certain embodiments and may be used as surface protection layer for the cladding 415 during transportation and through a fiber draw process of the preform 400.

FIG. 5 is a cross section of a fiber 500 with several cladding layers and cladding guiding optimized for fiber laser applications in accordance with embodiments of the present disclosure. The fiber 500 may be produced using the system 200 of FIG. 2, in certain embodiments. The fiber 500 includes a core 510 surrounded by a first cladding 520, which has a lower refractive index for light guiding in the core 510. The core 510 and cladding 520 may be made from non-oxide materials, such as for example ZBLAN, Indium Fluoride glass, chalcogenide glass, similar to the core 405 and cladding 410 of FIG. 4. The core 510 may, in certain embodiments, be doped with rare earth elements and serve as gain medium for fiber lasers and fiber amplifiers. The fiber 500 also includes a second cladding 530, which can be made of an oxide glass material. The glass transition temperature (Tg) of the cladding 530 may be higher than Tg of the core 510 and the cladding 520, for example, by approximately 5-20C in certain embodiments. The cladding 530 is surrounded by another cladding 540 that has Tg higher than cladding 530, for example, by 5-20C in certain embodiments. An example glass composition for the cladding 530 may be 42% P₂O₅, 21% Na₂O, 22% K₂O, and 15% ZnO. An example of composition for the cladding 540 may be 42% P₂O₅, 43% Na₂O, and 15% ZnO.

The presence of several claddings with variation of Tg across the fiber can allow for larger preforms and can compensate for temperature gradients during a fiber draw process from such preforms. Specifically, lower temperature central regions would become softer at the same time as outer regions with higher temperature, preventing potential overheating of the outer layers. The claddings 530 and 540 can be non-concentric to the core 510 and cladding 520 in certain embodiments, and also can be non-circular in certain embodiments (for example, polygon-shaped like the cladding 530 shown in FIG. 5). This can help to ensure cladding mode mixing in cladding-pumped fiber laser and fiber amplifier applications. The claddings 530 and 540 can have inclusions or voids (e.g., 550) in certain embodiments. Inclusions can be used for adding stress to the fiber and create birefringence for polarization maintaining light guidance. Voids can be used to create a low refractive index barrier and form high numerical aperture cladding guiding for cladding pumped fiber lasers and amplifiers. The fiber 500 also includes a coating 560, which can be a polymer coating, e.g., for protecting the glass fiber.

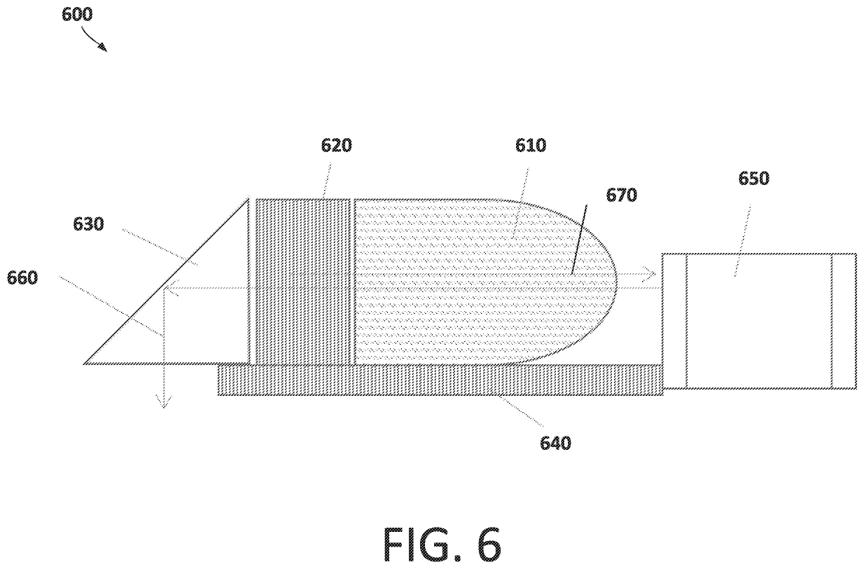

FIG. 6 is an example of an extruded optical element use for conditioning the output of semiconductor laser. The example system 600 shown in FIG. 6 includes a first optical element 610 that operates as cylindrical collimating lens. In some embodiments, the optical element 610 may be an aspheric lens to minimize light aberrations. The system 600 also includes a second optical element 620 that can act as distributed reflector. In some embodiments, the optical element 620 may be made out of photosensitive glass. The system 600 also includes a third optical element 630 that can further condition optical signals. For example, in some embodiments the optical element 630 may function as a turning prism or dispersing element. The system 600 also includes a structural element 640 that can be used as support for the optical elements 610, 620 and 630. The structural element 640 may function to hold the optical elements together and be used as a mounting means.

The system 600 further includes a light source 650, which may include a semiconductor laser light in certain embodiments. The light source 650 emits light 660 that is conditioned by the optical path that includes the optical elements 610, 620, 630. The light source 650 can also receive optical feedback 670 from the optical path that can affect its output 660. For example, the feedback 670 may stabilize the wavelength of the light emission 660 by returning narrow band reflection from a reflector grating in the optical element 620. Such a grating (e.g., a volume Bragg grating) can be formed using laser wring methods known in the state of the art for photosensitive glasses or by other methods.

Embodiments of the present disclosure could be used for infrared fiber patch cords fabrication with exceptional reliability and environmental stability for critical applications. Example: InF core of 100 micron diameter, InF cladding that has lower refractive index and delivers core light guiding NA of 0.2 to 0.3. The core and cladding are surrounded with oxide glass cladding with outer diameter around 200 microns. Embodiments of the present disclosure can also be used for other challenging glass parts fabrication tasks in vacuum, on the ground (normal gravity) and in space.

Aspects of the embodiments are directed to systems and methods for material processing in a low gravity environment, and specifically to low loss and high reliability optical elements, optical components, optical fibers, fiber preforms and planar light wave circuits manufacturing in space. The triple crucible extrusion system fabricates the fiber and fiber preforms that combine the benefits of low loss infrared fiber transmission of fluoride glass core with the environmental stability of the oxide glass outer cladding. The selection of glass compositions with specified glass transition temperatures and improved thermal conductivity enables scaling up the manufacturing process to larger performs and longer fiber lengths.

The following paragraphs provide example embodiments:

A system for fabrication of optical fibers and fiber preforms, comprising triple crucible extruder for forming the outer cladding oxide glass, and the low loss infrared fiber core surrounded by infrared fiber cladding.

A connectorized infrared optical fiber with improved environmental stability having Indium Fluoride core of approximately 100 micron diameter, surrounded by indium fluoride cladding that has lower refractive index than the core and enables the light propagation in the core with Numerical Aperture in the range of 0.2 to 0.3, and the oxide glass cladding surrounding the fluoride core and fluoride cladding with outer diameter of approximately 200 microns.

1. A system comprising:
a first apparatus to extrude a heated first glass material;
a second apparatus to extrude a heated second glass material around the first glass material; and
a third apparatus to extrude a heated third glass material around the second glass material.

2. The system of claim 1, wherein the first glass material is an infrared fiber core glass, the second glass material is an infrared cladding glass, and the third glass material is an oxide cladding glass.

3. The system of claim 2, wherein:
the first apparatus is to extrude a core glass comprising Indium Fluoride or ZBLAN (ZrF4-BaF2-LaF3-AlF3-NaF) and having a diameter of approximately 100 microns; and
the second apparatus is to extrude a cladding glass comprising Indium Fluoride or ZBLAN (ZrF4-BaF2-LaF3-AlF3-NaF) and having an outer diameter of approximately 200 microns.

4. The system of claim 1, wherein the first glass material and second glass material are each chalcogenide materials.

5. The system of claim 1, wherein the first apparatus, second apparatus, and third apparatus each comprise a heated syringe or heated crucible.

6. The system of claim 5, further comprising a set of nozzles, wherein each apparatus feeds a respective nozzle of the set of nozzles.

7. The system of claim 6, wherein the set of nozzles are concentric.

8. The system of claim 5, further comprising a moving platform, wherein each of the first apparatus, second apparatus, and third apparatus are to extrude onto a substrate on the moving platform.

9. The system of claim 8, further comprising a controller comprising circuitry to control the movement of the moving platform.

10. A method of forming an optical fiber comprising:
extruding, via a first apparatus in a low gravity environment, a core glass of an optical fiber;
extruding, via a second apparatus in a low gravity environment, a first cladding glass around the core glass of the optical fiber, the first cladding glass having a lower refractive index than the core glass; and
extruding, via a third apparatus in a low gravity environment, a second cladding glass around the first cladding glass.

11. The method of claim 10, wherein the core glass is an fluoride glass material, the second glass material is a fluoride glass material, and the third glass material is an oxide glass material.

12. The method of claim 11, wherein:
the core glass comprises Indium Fluoride or ZBLAN (ZrF4-BaF2-LaF3-AlF3-NaF) and is extruded at a diameter of approximately 100 microns; and
the first cladding glass comprises Indium Fluoride or ZBLAN (ZrF4-BaF2-LaF3-AlF3-NaF) and is extruded with an outer diameter of approximately 200 microns.

13. The method of claim 10, wherein the first glass material and second glass material are each chalcogenide materials.

14. The method of claim 10, wherein the first apparatus, second apparatus, and third apparatus each comprise a heated syringe or heated crucible.

15. The method of claim 10, wherein the first apparatus, second apparatus, and third apparatus extrude using concentric nozzles.

16. The method of claim 10, wherein the first apparatus, second apparatus, and third apparatus extrude onto a moving platform.

17. The method of claim 10, wherein a transition temperature of the second cladding glass is higher than a transition temperature of the core glass and the first cladding glass.

18. The method of claim 10, wherein the second cladding glass forms a majority portion of the optical fiber cross section.

19. The method of claim 10, further comprising coating the outside of the second cladding glass with a polymer material.

20. The method of claim 19, wherein the polymer material is a fluorinated ethylene propylene (FEP) material.
